(19) United States
(12) Patent Application Publication
(10) Pub. No.: US 2015/0101203 A1
(43) Pub. Date: Apr. 16, 2015

(54) SLOPE AND LEVEL ANGLE MEASURING DEVICE

(71) Applicant: J. Yen Ligh, Bellaire, TX (US)

(72) Inventor: J. Yen Ligh, Bellaire, TX (US)

(21) Appl. No.: 14/050,859

(22) Filed: Oct. 10, 2013

(51) Int. Cl. G01C 9/24

(52) U.S. Cl. CPC G01C 9/24
USPC 33/379

(57) ABSTRACT

A handheld device for finding the angle of a slope of a surface or verifying whether a surface is level or perpendicular which has a housing with a generally planer configuration, two perpendicularly intersecting straight edges, an arcuate slot comprising greater than 90° having a concave and a convex side positioned in said housing said concave side facing and opposed to said perpendicularly intersecting straight edges, a sealed tubular member filed with liquid and having one gas bubble therein, position along the arcuate slot and visible on at least one side of said housing. The tubular member is calibrated to determine 0 and 90 degree points which are marked on the housing and a plurality of indicia along said housing adjacent to said slot, indicating degrees between 0° to 90°.

### BACKGROUND OF THE INVENTION

1. Field of the Invention

The present invention relates to a handheld device of the genus of the ancient carpenter's level which uses no electrical or complicated mechanical components for finding the angle of a slope of a surface or verifying whether a surface is level or perpendicular. The functioning of the device is intuitive and would require little or no instruction or description.

2. Related Art

The carpenter's level, which employs straight bubble sight tubes and does not readily provide an observable measure of the actual angle in degrees.

### SUMMERY OF THE INVENTION

The present invention is a device comprising a housing having planer configuration, two perpendicularly intersecting straight edges, an arcuate slot comprising greater than 90° having a concave and a convex side positioned in said housing and opposed to said perpendicularly intersecting straight edges, said concave side facing said perpendicularly intersecting straight edges, a sealed tubular member filled with liquid and having one gas bubble therein, position along said 90° arcuate slot and visible on at least one side of said housing, said tubular member being calibrated to determine 0° and 90° points which are marked on the housing and a plurality of indicia along said housing adjacent to said arcuate slot and said tubular member, indicating degrees between 0° to 90°.

### BRIEF DESCRIPTION OF THE DRAWINGS

FIG. 1 is a side elevation of the present invention.

FIG. 2 is cross sectional view along line 2-2 of FIG. 1.

FIG. 3 demonstrates an example of the use of present invention.

### DETAILED DESCRIPTION OF THE INVENTION

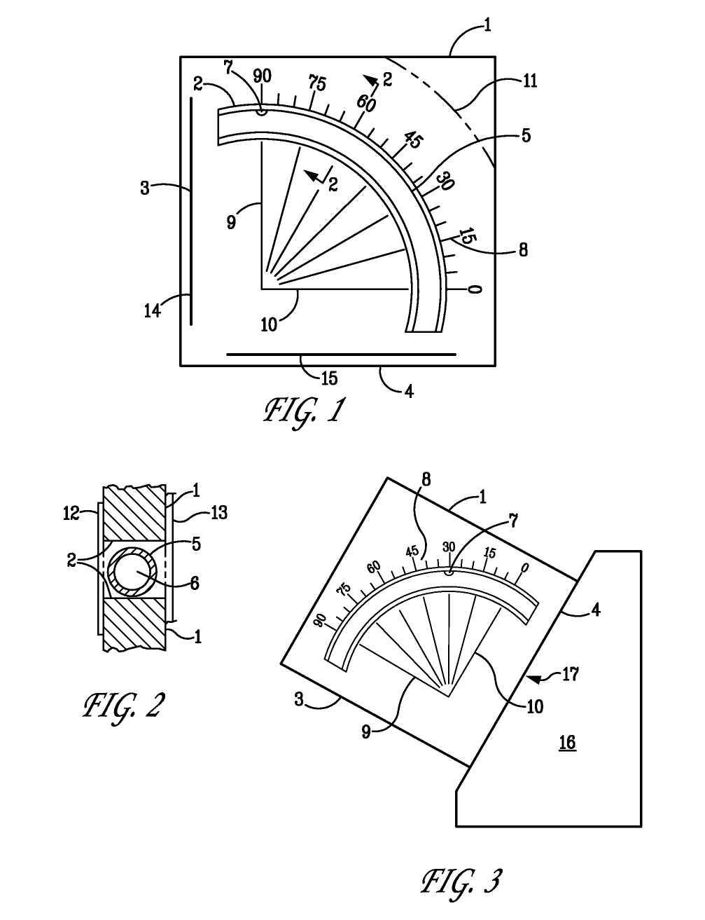

FIG. 1 shows a housing 1 made of a solid block such as plastic or wood, which in this embodiment is thicker than the tubular member 5 having an arcuate cutout slot 2 that is more than 90° of a circle. The housing has a generally planer configuration. The sides 3 and 4 of the housing 1 are perpendicular to each other forming a 90° corner. A translucent or transparent tubular member 5 is more than 90° of a circle and is fixed within the cutout of arcuate slot 2 in housing 1.

The arcuate slot and the tubular member extend beyond 0° and 90° to allow the bubble to center on the 0° and 90° marks usually about 10 degrees, although a greater or less amount may be use so long as the purpose is obtained. The tubular member 5 is preferably filled with a colored liquid 6 for ease of viewing, leaving a small gas (e.g. air) bubble 7. On both sides of the housing 1 along both sides of the arcuate slot are indicia in the form of degree marks 8 which are calibrated between 0° and 90° and are spread between lines 9 and 10 which are perpendicular to each other and parallel to sides 3 and 4, respectively.

The size of the housing will determine how many degree marks can be placed on the surface adjacent to the arcuate slot. Surface 11 (designated by a dotted line) is an alternative shape of the housing at the corner opposite the 90° corner created by intersecting surfaces 3 and 4. The surface opposite the 90° of surfaces 3 and 4 may be circular, straight or any shape. Optionally, transparent components 12 and 13 may be attached to housing 1 to protect tubular member 5. Optionally magnetic strips 14 and 15 may be imbedded in housing 1 along surfaces 3 and 4.

FIG. 3 shows one utilization of the present device. The gas bubble 7 will rise to the highest point along the tubular member. Either surface 3 or 4 is placed against the surface 17 of the object 16 to be measured and the degree mark at the center of the bubble is the angle of slope of the measured object surface. In the present example the bubble 7 is at the top of the arc of the tubular member which is 30° from vertical.

The invention claimed is:

1. A device comprising a housing having planer configuration, two perpendicularly intersecting straight edges,
an arcuate slot comprising greater than 90° having a concave and a convex side positioned in said housing and opposed to said perpendicularly intersecting straight edges, said concave side facing said perpendicularly intersecting straight edges,
a sealed tubular member filed with liquid and having one gas bubble therein, position along said 90° arcuate slot and visible on at least one side of said housing, said tubular member being calibrated to determine 0° and 90° points which are marked on the housing and
a plurality of indicia along said housing adjacent to said arcuate slot and said tubular member, indicating degrees between 0° to 90°.

2. The device according to claim 1, wherein said arcuate slot extends through said housing.

3. The device according to claim 2, wherein said indicia are on both sides of said housing adjacent to said arcuate slot.

4. The device according to claim 1, having transparent member covering said arcuate slot.

5. The device according to claim 1, wherein said liquid is colored.

6. The device according to claim 1, wherein a magnet strip is imbedded in housing adjacent to a perpendicularly intersecting straight edge.

7. The device according to claim 6, wherein a magnet strip is imbedded in housing adjacent to both perpendicularly intersecting straight edges.
